(19) United States
(12) Patent Application Publication
(10) Pub. No.: US 2013/0070255 A1
(43) Pub. Date: Mar. 21, 2013

(54) PROBE FOR OPTICAL TOMOGRAPIC IMAGE MEASUREMENT DEVICE AND METHOD FOR ADJUSTING PROBE

(71) Applicant: Fumio Nagai, Kunitachi-shi (JP)

(72) Inventor: Fumio Nagai, Kunitachi-shi (JP)

(21) Appl. No.: 13/509,778

(22) PCT Filed: Nov. 9, 2010
(86) PCT No.: PCT/JP2010/069911

§ 371 Date: May 14, 2012

(30) Foreign Application Priority Data
Nov. 17, 2009 (JP) 2009-261751

(51) Int. Cl. G01B 9/02

(52) U.S. Cl. CPC G01B 9/0205
USPC 356/479; 356/497

(57) ABSTRACT

A prism is attached to a refractive index dispersion lens by inclining the incident plane of the prism by a prescribed angle with respect to the end face of the refractive index dispersion lens and filling adhesive therebetween. In this way, the amount of light reflected from the bottom plane of the prism decreases in accordance with the angle of inclination of the incident plane, and the interference signal formed by the reflected light from the bottom plane of the prism, and the reflected light of a reference beam therefore weakens and the image signal decreases. Consequently, distinguishing between the image signal and the image signals produced by reflected light from the measurement subject is facilitated.

### TECHNICAL HELD

The present invention relates to a technology for measuring optical tomographic images using an OCT (Optical Coherence Technology), to obtain an optical tomographic image.

### BACKGROUND OF THE INVENTION

In recent years, endoscopic devices for measuring the interior of a body cavity of a living subject are used in various fields, wherein while images of the living body are illuminated by illumination beam, said images are photographed due to a reflected beam coming from the living body, and the photographed images are displayed on a monitor. Further, most of the endoscopes include a forceps entrance for guiding a probe into the living body through a forceps channel, so that biopsy of tissues in the body cavity can be conducted for treatment of the patient.

As the above-detailed endoscopic devices, well-known is an ultrasonic tomographic image obtaining device using ultrasonic waves, while as another device, listed is an optical tomographic imaging device, which uses the optical interference by low coherence beam (see Patent Document 1). According to the optical tomographic imaging device cited in Patent Document 1, after the low coherent beams are emitted from a light beam source, said low coherent beam is divided into a measurement beam and a reference beam. The measurement beam is radiated onto a measurement subject, and a reflected beam from the measurement subject is guided to an optical multiplexing means. In order to change a measuring depth in the measurement subject, after an optical path length is changed, said reference beam is guided to the optical multiplexing means. The reflected beam and the reference beam are multiplexed by the optical multiplexing means, and interfering beam generated due to multiplexing is measured by heterodyne detection or the like.

Further, when the measurement beam is radiated onto the measurement subject, a probe is used, which is introduced into the body cavity from the forceps entrance of the endoscope through the forceps channel. The probe includes an optical fiber for guiding the measurement beam, and a mirror for reflecting the measurement beam at a right angle or a flat plate through which the measurement beam is transmissive, which are arranged on a top of the optical fiber. Through said probe, the measurement beam is radiated onto the measurement subject in the body cavity, and the reflected beam from the measurement subject is again guided to the optical multiplexing means through the optical fiber of the probe. At this time, a technology is used in which coherent beams can be detected, when the optical path lengths of the measurement beam and the reflected beam, and the optical path length of the reference beam are equal to each other. That is, the optical path length of the reference beam is changed so that a measuring position (being a measuring depth) against the measurement subject can be changed. This is called as an OCT measurement.

### PRIOR ART DOCUMENT

### Patent Document

PATENT DOCUMENT 1: UNEXAMINED JAPANESE PATENT APPLICATION PUBLICATION NO. 2008-86414

### SUMMARY OF THE INVENTION

### Problems to be Solved by the Invention

However, there is a problem on the optical tomographic imaging device. That is, when the probe is introduced into the living cavity of a living subject, precise positional relationships between a tissue and the probe cannot be obtained. If the precise positional relationships between the tissue and the probe cannot be obtained, a precise optical path length of the reference beam cannot be determined, so that the tissue tends to go out from a measurable scope, whereby it is not possible for the device to obtain a tomographic image of said tissue. To overcome this problem, it may be possible that while referring to the prior art in Patent Document 1, a window section is arranged on an external cylinder of the probe, whereby the optical beam path length of the reference beam is determined by the reflected beam from a window section. However, since the amount of the reflected beam coming from the window section cannot be adjusted, when the reflected beam is detected with the beam coming from the tissue of the living subject, noises will be generated, or confusion with the tomographic image will be generated. Further, since a prism is rotated to reflect the measurement beam, the distance between the window section and the prism is changed, whereby a problem occurs that the optical path length of the reference beam cannot be precisely adjusted.

The present invention has been achieved to solve the above problems, and an object of the present invention is to offer a probe of the optical tomographic image measuring device which can easily detect an optical tomographic image and control confusion with the noise, and to offer a method for adjusting said probe.

### Means to Solve the Problems

A probe for an optical tomographic image measurement device described in Claim 1, wherein the optical tomographic image measurement device includes a main body for obtaining an optical tomographic image of a measurement subject, and the probe for guiding measurement beams to the measurement subject, the optical tomographic image measurement device further includes: a light beam source for emitting low coherent beams; a light beam dividing means for dividing the low coherent beams emitted from the light beam source into measurement beams and reference beams; a reflection mirror for reflecting the reference beams divided by the light beam dividing means, and for giving a predetermined optical path length to the reference beams; an optical multiplexing means for multiplexing measured reflected beams returning from the measurement subject at a time when the measurement beams from the probe are radiated onto the measurement subject, and the reference beams reflected by the reflection mirror, and an optical interfering beam detection means for detecting optical interfering beams which are interfered with the measured reflected beams multiplexed by the optical multiplexing means and the reference beams, wherein the probe is characterized by a partially reflecting surface for reflecting some of the measurement beams at a position of a fixed measurement optical path length, and directing said some of the measurement beams to the optical multiplexing means.

According to the present invention, since the probe includes the partially reflecting surface for reflecting a part of the measurement beams at the position of the fixed optical path length which has been fixed, an optical path length to the partially reflecting surface can be fixed, whereby the optical path length of the reference beam is adapted to this length, and image signals based on the reflected light from the partially reflecting surface on the optical tomographic image can be precisely detected. Further, when the probe is introduced into the body cavity of a living subject, images, which are based on the reflected beam coming from the partially reflecting surface, are used so that images, which are based on the reflected beams from the tissue of the living subject, can be easily determined. “The partially reflecting surface” includes a reflection surface (which is a half mirror, for example) to make some of incident beams to be transmissive and to reflect the remaining incident beams at the same area, and a reflection surface to make incident beams to be transmissive at a part of an area of the reflection surface, and to reflect the incident beams at the remaining area of the reflection surface. In particular, it is preferable for the probe that the partially reflecting surface is a surface exhibiting maximum reflection among the total reflection surface in the probe. Still further, “fixed optical path length” means a physical optical path length of a media through which the light beams are transmitted, whereby an optical path length, which varies in accordance with the change of refraction index of media due to the temperature change, is not included.

The probe of the optical tomographic image measurement device described in claim 2 is characterized in that on the invention described in claim 1, an optical member having the partially reflecting surface on the probe is arranged to exhibit a position where an amount of the beam returning from the partially reflecting surface includes a predetermined ratio against an amount of the measurement beam entering the partially reflecting surface, whereby images, which are based on the reflected beam coming from the partially reflecting surface, are used so that images, which are based on the reflected beam from the tissue of the living subject, can be easily determined.

The probe of the optical tomographic image measurement device described in claim 3 is characterized in that on the invention described in claim 2, the predetermined ratio is equal to or greater than 60 dB, and equal to or less than 25 dB. In this case, 1 dB=−10 log(X[%]/100), and “X” represents a ratio of an amount of the beam coming from the partially reflecting surface, against an amount of beam entering the probe.

Interference signals generated in a common optical path (which is in the reference optical path only, or in the measurement optical path only), such as interference signals, based on the reflected beams coming from the partially reflecting surface and the reflected beams coming from the measurement subject, can be removed within a predetermined scope, if a balance detector as a detection device is used. In general, since the balance detector (for example, 80-MHz Balanced Receiver, made by NewFocus) can remove a common mode of 20-30 dB, if the reflectance on the partially reflecting surface in the probe is set to be equal to or less than 25 dB, the interference signals, based on the reflected beams coming from the measurement subject and the reflected beams coming from the partially reflecting surface, can be removed, so that clear optical tomographic image signals can be obtained. Further, if the reflectance of the partially reflecting surface in the probe is equal to or greater than 60 dB, the signals, which are generated by the interference of the reference beams passing through the reference path and the internal reflected beams, can be effectively detected by the optical tomographic image measurement device. However, if said reflectance is equal to or less than 60 db, the optical tomographic image signals of the internal reflection of the probe are so weak that the signals are very difficult to be detected.

The probe of the optical tomographic image measurement device described in claim 4 is characterized in that the probe in the invention described in claims 1-3 further includes: an optical fiber for receiving the measurement beam and returning the measurement reflected beam; a refractive index dispersion lens for transferring the measurement beam and the measured reflected beam; and a prism for outputting the measurement beam through the partially reflecting surface and receiving the measured reflected beam, wherein the refraction index dispersion lens and the prism are adhered onto each other, while keeping a predetermined positional relationships. Due to this, the amount of the returned beams, returning from the partially reflecting surface, can be controlled at a desired ratio, against the amount of conveyed measurement beams.

The probe of the optical tomographic image measurement device described in claim 5 is characterized in that in the invention described in claim 4, the refractive index dispersion lens and the prism are adhered onto each other while keeping a predetermined angle. Due to this, the optical amount of the beams returning from the partially reflecting surface can be easily controlled, against the optical amount of conveyed measurement beam.

The probe of the optical tomographic image measurement device described in claim 6 is characterized in that in the invention described in claim 4, the refractive index dispersion lens and the prism are adhered to each other while keeping a predetermined clearance. Due to this, the optical amount of the beams returning from the partially reflecting surface can be easily controlled, against an optical amount of radiated measurement beam.

The probe of the optical tomographic image measurement device described in claim 7 is characterized in that in the invention described in claims 1-6, the partially reflecting surface is placed at a position which keeps an optical path length from a focal point of the refractive index dispersion lens to be equal to or less than 10 mm. Due to this, both interference signals returned from the measurement subject and interference signals coming from the partially reflecting surface of the probe can be placed within a measurable scope in the depth direction of the optical tomographic image.

The measurable scope in the depth direction of the optical tomographic image depends on various factors, such as the number of samplings for detecting the interference signals, the coherence length of the light beam source, the light beam source transmittance of the measurement subject, or the like. As one of marks, Reilly length is considered. The Reilly length represents an approximate guide for the measurable scope, that is, the focal depth is double the Reilly length, and Reilly length Z is shown by Z=λ/(π·NA²), in which λ is wave length of the light beam source, NA is a light beam exhibiting an intensity of 1/e² of the beam focused by a condenser lens. For example, regarding the optical tomographic image measurement device to be used for an in-vivo measurement, generally used are a light beam source exhibiting a wave length 1.3 μm, and a condenser lens (which is the refractive index dispersion lens in this case) exhibiting NA 0.01, so that the focal depth results in 8.3 mm. Accordingly, it is desirable to place the partially reflecting surface at a position which keeps the optical path length from the focal point of the refractive index dispersion lens to be equal to or less than 10 mm.

The probe of the optical tomographic image measurement device described in claim 8 is characterized in that the probe in the invention described in claims 1-3 further includes: an optical fiber for conveying the measurement beam and returning the measurement reflected beam; a lens for transferring the measurement beam and the measurement reflected beam; a flat plate for conveying the measurement beam through the partially reflecting surface and receiving the measurement reflected beam, and a lens barrel for uniting the optical fiber, the lens and the flat plate, wherein the flat plate united in the lens barrel is inclined against an optical axis. Due to this structure, the amount of beams returning from the partially reflecting surface can be controlled at a desired ratio, against the amount of radiated measurement beam.

The probe of the optical tomographic image measurement device described in claim 9 is characterized in that in the invention described in claim 8, the partially reflecting surface is placed at a position which keeps an optical path length from the focal point of the lens to be equal to or less than 10 mm. Due to this, both interference signals coming from the measurement subject and interference signals coming from the partially reflecting surface of the probe can be placed within a measurable scope in the depth direction of the optical tomographic image.

A method for adjusting a probe described in claim 10 is a method for adjusting a probe of an optical tomographic image measurement device including a main body for obtaining an optical tomographic image of a measurement subject and a probe for guiding a measurement beam to the measurement subject, wherein the optical tomographic image measurement device includes: a beam source for emitting low coherent beams; a beam dividing means for dividing the low coherent beams emitted from the beam source into a measurement beam and a reference beam; a reflection mirror for reflecting the reference beam divided by the optical dividing means and for giving a predetermined optical path length to the reference beam; an optical multiplexing means for multiplexing a measurement reflected beam coming from said measurement subject, at a time when the measurement beam coming from the probe is radiated onto the measurement subject, and the reference beam reflected by the reflection mirror, and an optical interference detection means for detecting the optical interfering beam which is interfered with the measurement reflected beam multiplexed by the optical multiplexing means and the reference beam, wherein the probe includes a partially reflecting surface for reflecting a part of the measurement beam at a position of a measurement optical path length, having been fixed, and guiding said part of the measurement beam to the optical multiplexing means, wherein while a measurement beam is sent to the partially reflecting surface and a return beam returning from the partially reflecting surface is detected, so that the partially reflecting surface is fixed to keep an attitude in such a manner that the amount of the return beam returning from the partially reflecting surface exhibits a predetermined ratio against the amount of the radiated measurement beam.

According to the present invention, while the measurement beam is sent to the partially reflecting surface, the return beam from the partially reflecting surface is detected, whereby the partially reflecting surface is controlled to keep its attitude in such a manner that the amount of the return beam returning from the partially reflecting surface exhibits a predetermined ratio against the amount of the measurement beam, whereby the optical path length to the partially reflecting surface can be fixed, and the optical path length of the reference beam is set to be equal to the optical path length to the partially reflecting surface. Accordingly, the image signals, which are based on the reflected beam coming from the partially reflecting surface concerning the optical tomographic image, can be detected with a high degree of accuracy. Further, when the probe is actually introduced into the body cavity of the real living subject, images, which are based on the reflected beam coming from the partially reflecting surface, are used so that images, which are based on the reflected beam coming from the tissue of the living subject, can be easily determined.

The method for adjusting the probe described in claim 11 is characterized in that, the predetermined ratio is equal to or greater than 60 dB, and equal to or less than 25 dB, in the invention described in claim 10.

The method for adjusting the probe described in claim 12 is characterized in that, in the invention described in claim 10 or 11, the probe includes: an optical fiber for conveying the measurement beam and returning the measurement reflected beam; a refractive index dispersion lens for transferring the measurement beam and the measurement reflected beam; and a prism for conveying the measurement beam through the partially reflecting surface and returning the measurement reflected beam, wherein the refraction index dispersion lens and the prism are adhered to each other, while keeping a predetermined positional relationships. Due to this, the amount of return beam, coming from the partially reflecting surface, can be controlled as a desired ratio, against the amount of radiated measurement beam.

The method for adjusting the probe described in claim 13 is characterized in that, in the invention described in claim 12, the refraction index dispersion lens and the prism are adhered to each other while keeping a predetermined angle. Due to this, the optical amount of the returned beam returning from the partially reflecting surface can be easily controlled, against the optical amount of radiated measurement beam.

The method for adjusting the probe described in claim 14 is characterized in that, in the invention described in claim 12, the refractive index dispersion lens and the prism are adhered to each other while keeping a predetermined clearance. Due to this, the optical amount of return beam returning from the partially reflecting surface can be easily controlled, against an optical amount of radiated measurement beam.

The method for adjusting the probe described in claim 15 is characterized in that, in the invention described in claims 10-14, the partially reflecting surface is placed at a position which keeps the optical path length from the focal point of the refractive index dispersion lens to be equal to or less than 10 mm. Due to this, both interference signals returned from the measurement subject and interference signals coming from the partially reflecting surface of the probe can be placed within a measurable scope in the depth direction of the optical tomographic image.

The method for adjusting the probe described in claim 16 is characterized in that, in the invention described in claim 10 or 11, the probe includes: an optical fiber for conveying the measurement beam and returning the measurement reflected beam; a lens for transferring the measurement beam and the measurement reflected beam; a flat plate for conveying the measurement beam through the partially reflecting surface and receiving the measurement reflected beam, and a lens barrel for uniting the optical fiber, the lens and the flat plate, wherein the flat plate united in the lens barrel is inclined against the optical axis. Due to this structure, the amount of return beam returning from the partially reflecting surface can be controlled at a desired ratio, against the amount of radiated measurement beam.

The method for adjusting the probe described in claim 17 is characterized in that, in the invention described in claim 16, the partially reflecting surface is placed at a position which keeps an optical path length from the focal point of the lens to be equal to or less than 10 mm. Due to this, both interference signal coming from the measurement subject and interference signal coming from the partially reflecting surface of the probe can be placed within a measurable scope in the depth direction of the optical tomographic image.

### Effect the Invention

According to the present invention, a probe of the optical tomographic image measurement device and methods for adjusting said probe can be offered, wherein the probe is formed to be a simple structure, and the image signals are prevented from fixing to noises.

### BRIEF DESCRIPTIONS OF THE DRAWINGS

FIG. 1 is an exterior pattern diagram to show a preferable embodiment of an optical tomographic image measurement device.

FIG. 2 is a block diagram to show the preferable embodiment of the optical tomographic image measurement device of the present invention.

FIG. 3 is a cross-sectional view to show an example of a top section of a probe of the optical tomographic image measurement device shown in FIG. 1.

FIG. 4 a cross-sectional view to show an example of a driving device of the probe of the optical tomographic image measurement device shown in FIG. 1.

FIG. 5 is a cross-sectional view to show an example of a rotation driving unit of the optical tomographic image measurement device shown in FIG. 1.

FIG. 6 is a schematic view to explain the fundamental principle of an OCT measurement.

FIG. 7 is a schematic cross-sectional view of a probe relating to a comparative example.

FIG. 8 is a schematic cross-sectional view of the probe relating to the present embodiment.

FIG. 9 is a drawing to show depth tomographic signals of a measurement subject, where the signal intensity is shown on the vertical axis, and the depth length of the measurement subject is shown on the horizontal axis.

FIG. 10 is a schematic view to show a measurement device to measure the reflectance ratio.

FIG. 11 is a schematic cross-sectional view of a probe relating to a variant example.

FIG. 12 is a schematic cross-sectional view of a probe relating to another embodiment.

### DETAILED DESCRIPTIONS OF THE PREFERRED EMBODIMENT

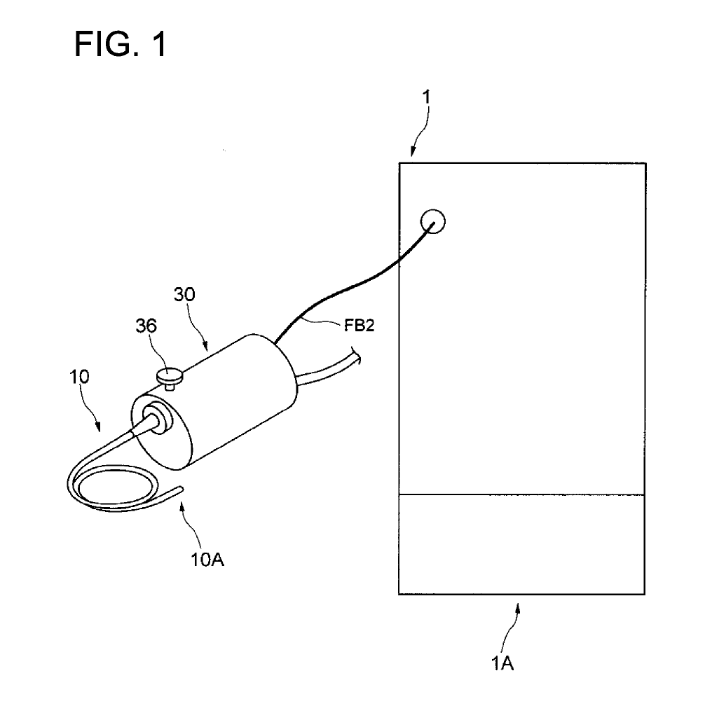

The embodiment of the present invention will now be detailed while referring to the drawings. FIG. 1 is an exterior pattern diagram to show a preferable embodiment of an optical tomographic image measurement device. Optical tomographic measurement device 1 is structured of main body 1A, which is configured to obtain optical tomographic images of a measurement subject due to an optical coherent tomography measurement, and probe 10, which is configured to be detachable to main body 1 and conveys the measurement beam to the measurement subject. Plural probes 10 are prepared to be connected to main body 1A. After disconnected from main body 1A, probe 10 is washed and cleaned. New probe 10 is subsequently adapted to main body 1A.

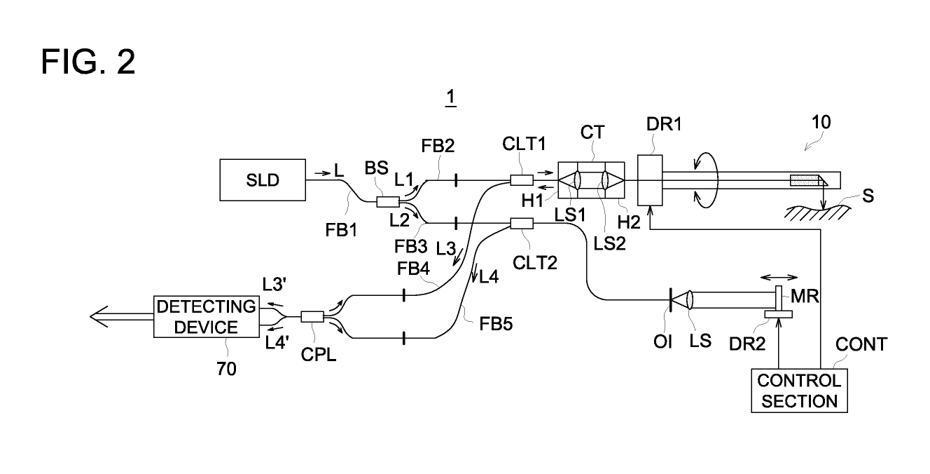

FIG. 2 shows the schematic block diagram of the optical tomographic image measurement device relating to the present embodiment. SS (Swept Source)—OCT structure is used in this case. Main body 1A of optical tomograpghic image measurement device 1 includes: light beam source SLD to radiate low coherent beam L; optical dividing means BS for dividing low coherent beam L radiated from light beam source SLD into measurement beam L1 and reference beam L2; first circulator CLT1 to guide measurement beam L1, divided by optical dividing means BS, toward probe 10, and to guide measurement beam L1, coming from probe 10, to interfering beam detecting device 70; connector CT, which is provided between first circulator CLT1 and probe 10, allows probe 10 to rotate; probe 10 to guide measurement beam L1 to measurement subject S; second circulator CLT2 to guide reference beam L2, divided by optical dividing means BS, to reflection mirror MR, and to guide reference beam L2, coming from reflection mirror MR, to interfering beam detecting device 70; outlet-inlet end OI, which is provided between second circulator CLT2 and reflection mirror MR, to output reference beam L2 to reflection mirror MR through lens LS, and to input reflected beam L4, coming from reflection mirror MR, through lens LS; reflection mirror MR; coupler (being an optical multiplexing means) CPL to couple reflected beam L3, reflected by measurement subject S when measurement beam L1, coming from probe 10, is radiated onto measurement subject S, with reflected beam L4, coming from reflection mirror MR; and interfering beam detecting device 70 (being the interference light detecting means) to detect interfering beam L3, multiplexed by coupler CPL, and interfering beam L4. Light beam source SLD is capable of wave scanning, so that depth information for measurement subject can be obtained. Light beam source SLD, connector CT, outlet-inlet end OI, and interfering beam detecting device 70, are connected by optical fibers FB1-FB5, through which various light beams pass.

Control section CONT is configured to control probe driving device DR1 and mirror driving device DR2. Probe driving device DR1 can rotate probe 10, while mirror driving device DR2 can move reflection mirror MR at desirable lengths in the optical axial direction.

Light beam source SLD is formed of a laser beam source to radiate low coherent beams, such as SLD (Super Luminescent Diode), and ASE (Amplified Spontaneous Emission). Since optical tomograpghic image measurement device 1 functions to obtain tomographic images of a living subject in a body cavity serving as measurement subject 5, said device 1 can control the optical attenuation caused by optical scattering or absorption, to the lowest limit, preferably uses ultra-short pulse laser beam source for wide spectrum bands.

Optical dividing means BS, formed of a 1×2 optical fiber coupler, for example, functions to divide low coherent beam L, conveyed from light beam source SLD through optical fiber FB1, into measurement beam L1 and reference beam L2. Optical dividing means BS is optically connected to optical fiber FB2 and FB3, whereby measurement beam L1 is conveyed through optical fiber FB2, while reference beam L2 is conveyed through optical fiber FB3.

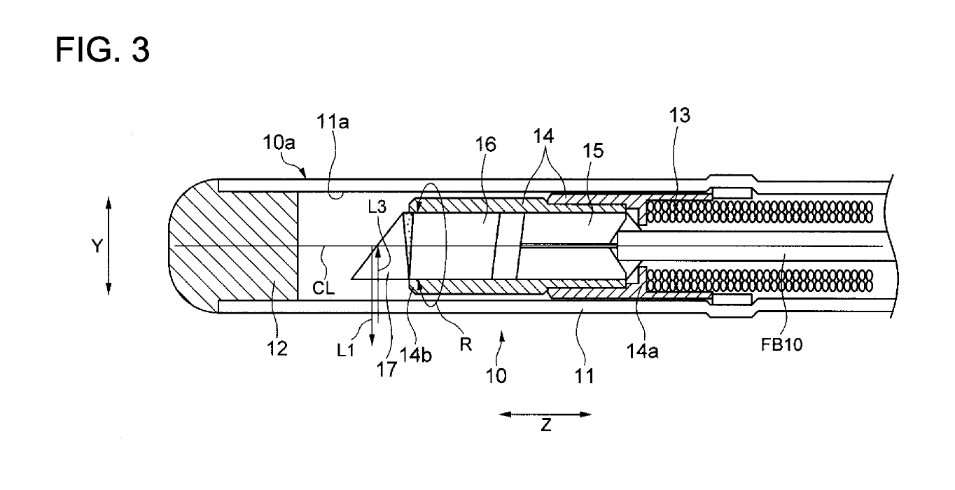

Since optical fiber FB2 is optically connected to probe 10 through detachable connector CT, measurement beam L1 is conveyed from optical fiber FB2 to probe 10 through connector CT. Connector CT, which functions to connect the end sections of the optical fibers to each other, is configured to hold lenses LS1 and LS2 by paired holders H1 and H2, which are relatively rotatable, wherein lenses LS1 and LS2 function to receive the optical beam outputted from the end section of one optical fiber, and to send said optical beam to the end section of another optical fiber. Even when holder H2 is rotated integrally with probe 10, holder H1 can be in the resting state. Accordingly, the optical fiber at the opposite side of probe 10 is not twisted. FIG. 3 is a cross-sectional view to show top section 10A of probe 10, probe 10 will now be detailed while referring to FIG. 1 and FIG. 3.

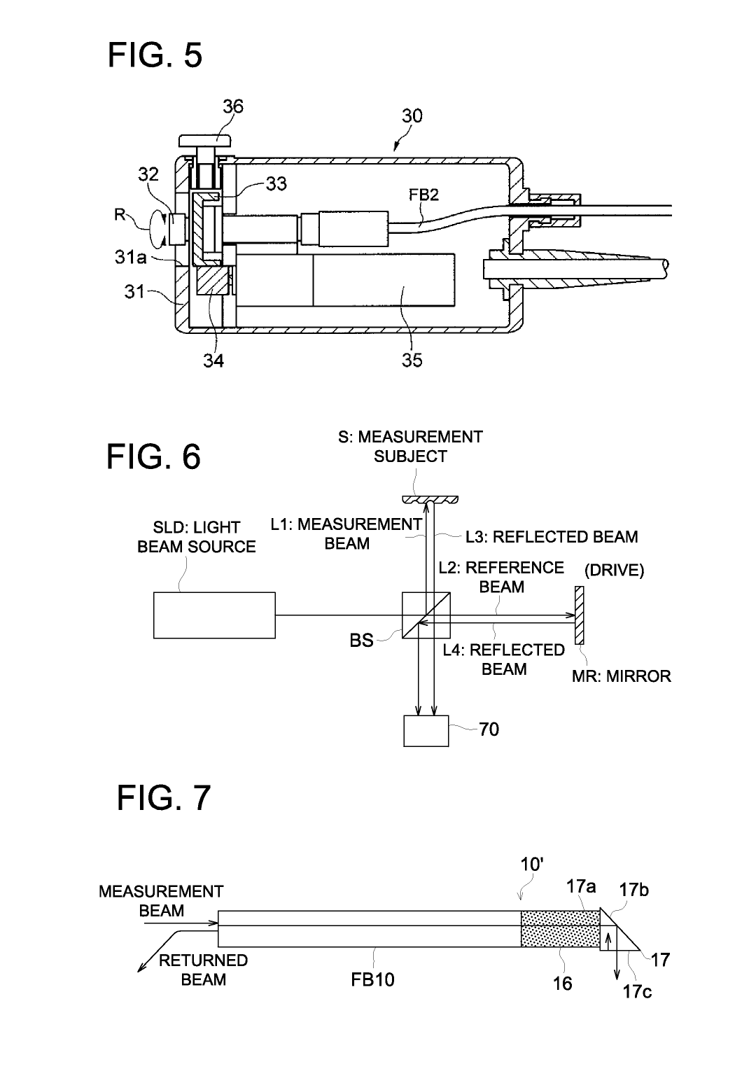

Probe 10, connected to rotation driving unit 30 (FIG. 5), is introduced into a body cavity from a forceps entrance through a forceps channel, and probe 10 is rotatable. In FIG. 3, probe 10 includes tube 11, optical fiber FB10 accommodated within tube 11, and prism 17 to reflect measurement beam L1 coming through optical fiber FB1, onto measurement subject S. Tube 11 is formed of a flexible and photo-transmittable material, such as resin. Cap 12 is fixed on the top of tube 11 so that the interior of tube 11 can be sealed.

Flexible shaft 13 is accommodated in tube 11, and optical fiber B10 is accommodated in flexible shaft 13. Flexible shaft 13 is formed of double compression coils, formed of metallic wires wound in a spiral configuration, while their winding directions are different from each other. Symbol CL represents an optical axis of optical fiber FB10.

The top of flexible shaft 13 and the top of optical fiber FB10 are fixed on one end 14a of base 14, while prism 17 is fixed on the other end 14b of base 14. A fixing method of prism 17 will be detailed later. Ferrule 15 and refractive index dispersion lens (being a gradient index lens, or a GRIN lens) 16 are accommodated in base 14. Accordingly, measurement beam L1 outputted from optical fiber FB10 is guided by ferrule 15 and gradient index lens 16, and is then conveyed to prism 17.

Prism 17 reflects measurement beam L1, conveyed through optical fiber FB10, to side surface 11a of tube 11, that is, measurement beam L1 is conveyed through tube 11 and radiated to the measurement subject. Simultaneously, prism 17 receives reflected beam L3 reflected by measurement subject S on which measurement beam L1 has been radiated, and prism 17 reflects said beam L3 to optical fiber FB10.

Flexible shaft 13 and optical fiber FB10 are configured to be rotatable against tube 11 in a direction shown by arrow R. Due to the rotations of flexible shaft 13 and optical fiber FB10, base 14 and prism 17 are also rotated in direction R. Accordingly measurement beam L1, reflected by prism 17, is radiated onto measurement subject S, while said measurement beam L1 is rotating. Due to this, optical tomographic images in a rotating direction (which is a radial direction) in the body cavity can be obtained.

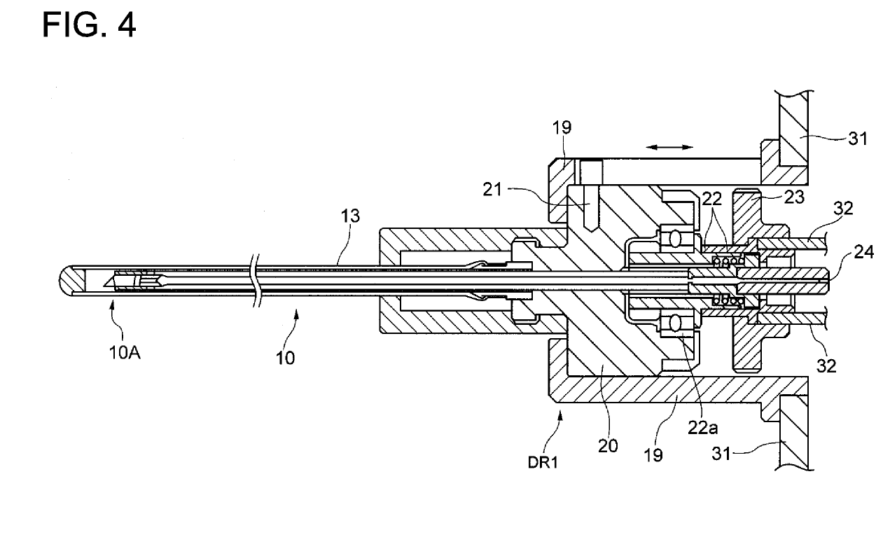

FIG. 4 is a cross sectional view to show an example of probe driving device DR1 of probe 10. Probe driving device DR1 includes rotation driving unit 30 to rotate probe 10, cover 19 to be fixed on rotation driving unit 30, fixed sleeve 20 to be accommodated on cover 19, rotary tube 22 being rotatable against fixed sleeve 20, and connection ring 23 to fix rotary tube 22 with rotary connector 32 of rotation driving unit 30. Cover 19 is structured to be fixed on body 31 of rotation driving unit 30, while being slidable against fixed sleeve 20. Fixed sleeve 20 is structured to be fixed on cover 19 by fixing member 21.

Rotary tube 22 is rotatably supported by fixed sleeve 20 through bearing 22a. Further, rotary tube 22 is fixed to flexible shaft 13, so that flexible shaft 13 is rotated due to rotation of rotary tube 22. Still further, connecting ring 23 is connected to rotary tube 22, and screw threads are formed inside connecting ring 23. After connecting ring 23 is fixed on rotary connector 32, rotary tube 22, rotary tube 22 is rotated in synchronization with rotary connector 32. Ferrule 24 is accommodated in rotary tube 22, so that optical fiber FB10 and optical fiber FB2 of rotation driving unit 30 are optically connected to each other through ferrule 24 (said connecting figure is not illustrated).

FIG. 5 is a cross sectional view to show an example of rotation driving unit 30. Rotation driving unit 30 shown in FIG. 5 functions to rotate optical fiber FB10 and prism 17, both of which are mounted in tube 11, in arrow direction R. Rotation driving unit 30 includes body 31 carrying connector entrance 31a through which connector CT is inserted, rotary connector 32 to connect to connector CT which protrudes from connector entrance 31a, and motor 35 which rotates rotary connector 32. Rotary connector rotates in synchronization with gear 33, and gear 33 is connected to gear 34 which is fixed to a rotation shaft of motor 35. When motor 35 is driven, rotary connector 32 is rotated through gears 33 and 34. Further, when stopper 36, mounted on rotation driving unit 30, is pushed to come into contact with gear 33, stopper 36 prevents rotary connector 32 from rotating.

Operations of probe 10 and rotation driving unit 30 will now be detailed, while referring to FIGS. 2-5. When motor 35 in rotation driving unit 30 is activated to rotate, rotary connector 32 rotates so that rotation tube 32 of probe 10, being connected to rotary connector 32, rotates. Due to this, flexible shaft 13, fixed on rotation tube 22, is rotated, whereby optical fiber FB10 and prism 17 rotate in arrow direction R. Accordingly, measurement beam L1, which is reflected by prism 17, is rotated in arrow direction R, and is radiated onto measurement subject S. Further, as detailed above, flexible shaft 13 is structured of two compression coils, each exhibiting a different winding direction, in whichever direction flexible shaft 13 may be rotated, a rotation force can be transferred to base 14 (see FIG. 4). However, since connector CT has an allowable rotational function, the optical fiber of first circulator CLT1 is not rotated together.

Coupler CPL, formed of 2×2 optical fiber, is configured to superpose reflected beam L4, reflected by reflection mirror MR, and reflected beam L3, reflected by measurement subject S, and divide said beams by 50:50 ratio, whereby signal intensities of interference signals are shifted to each other by phase π, so that interfering beams L3′ and L4′ are sent to interfering beam detecting device 70.

Interfering beam detecting device 70, also known as a balance detector, is configured to conduct a difference detection, that is, only an interference component of the interference signal is selected and detected. In detail, if the summation (hereinafter, referred to as “measurement optical path length”) of a total optical path length of measurement beam L1 and a total optical path length of reflected beam L3 is nearly equal to the summation (hereinafter, referred to as “reference optical path length”) of a total optical path length of reference beam L2 and a total optical path length of reflected beam L4, or if the difference between said two optical path lengths is within the coherence length, said two optical beams cause interference, and beat signals, due to the interference component, are created on the interference signals, when the wavelengths of light beam source SLD are scanned. Since the phase of the beat signal of the interference signals is shifted by it, due to the passage through the coupler exhibiting 50:50, when the difference of said two signals is obtained, the interference component of the interference signals, that is, only the beat signal can be selected and detected, and signals other than that can be subtracted, whereby depth information for the measurement subject can be obtained with high accuracy. Tomographic signals of the measurement subject is obtained due to a signal process operation of the interference signals, by a signal processing means which is not illustrated. Based on said tomographic signals, optical tomographic images are displayed on an image displaying means which is not illustrated. As detailed above, interfering beam detecting device 70 conducts the difference detection, which is one of means for effectively obtaining the interference component of the interference signals. Accordingly, it is possible for another means that the interference signals is directly detected without conducting the difference detection, and obtained interference signals is processed.

Optical tomographic image measurement device 1 will now be detailed below. In FIG. 2, low coherent beam L, emitted from light beam source SLD, passes through optical fiber FB1, and is divided into measurement beam L1 and reference beam L2 by optical dividing means BS. Measurement beam L1, divided by optical dividing means BS, passes through optical fiber FB2 and first circulator CLT1. Said measurement beam L1 passes through connector CT, and is radiated onto measurement subject S from probe 10. Reflected beam L3, reflected by measurement subject S, returns while passing again through probe 10 and connector CT. Said reflected beam L3 is guided by first circulator CL1 to coupler CPL through optical fiber FB4. Meanwhile, reference beam L2, divided by optical dividing means BS, passes through optical fiber FB3 and second circulator CLT2. Said reference beam L2 passes through outlet-inlet end OI and lens LS, and reaches reflection mirror MR. Reference beam L2, reflected by reflection mirror MR, is altered to reflected beam L4, and passes through lens LS and outlet-inlet end OI. Said reflected beam L4 is guided by second circulator CL2 to coupler CPL through optical fiber FB5. Reference beam L2 and reflected beam L4 are superposed by coupler CPL to be reference beam L3′ and reflected beam L4′. The difference between said reference beam L3′ and reflected beam L4′ are obtained to be processed by interfering beam detecting device 70, whereby interference signals depending on said difference are generated.

FIG. 6 is a schematic view to explain the fundamental principle of an OCT measurement. The fundamental principle of TD (Time Domain)—OCT measurement will be detailed while referring to FIG. 6. In FIG. 6, the low coherence light beam emitted from light beam source SLD is divided by optical dividing means BS. Measurement beam L1 goes to measurement subject S, and reflected beam L3 returns from measurement subject S to optical dividing means BS. Reference beam divided by optical dividing means BS goes to mirror MR, and reflected beam L4 returns from mirror MR to optical dividing means BS. Reflected beams L3 and L4 are superposed by optical dividing means BS, and superposed beams go to interfering beam detecting device 70 to be detected. In this case, measurement beam L1 creates reflected beams L3 at various positions in the depth direction of measurement subject S, due to the difference in refractive indexes of internal tissues of measurement subject S. That is, reflected beam L3 includes plural light beams, which have passed through various optical path lengths. While reflection mirror MR of the reference beam is shifted in the optical axial direction, when the total optical path length of reference beam L2 and reflected beam L4 becomes nearly equal to the total optical path length of measurement beam L1 and reflected beam L3, the optical interference occurs between reflected beam L3, reflected by measurement subject S, and light beam L4, reflected by the mirror, so that depth information of the measurement subject can be obtained. Signal processes are conducted for the interference signals, detected by interfering beam detecting device 70, so that as shown in FIG. 9, image signals WS can be detected, which include various peaks, at boundary surfaces of the refractive index in the depth direction of the internal tissues. Accordingly, when image processing is conducted based on image signals WS, tomographic images of the internal tissues can be formed.

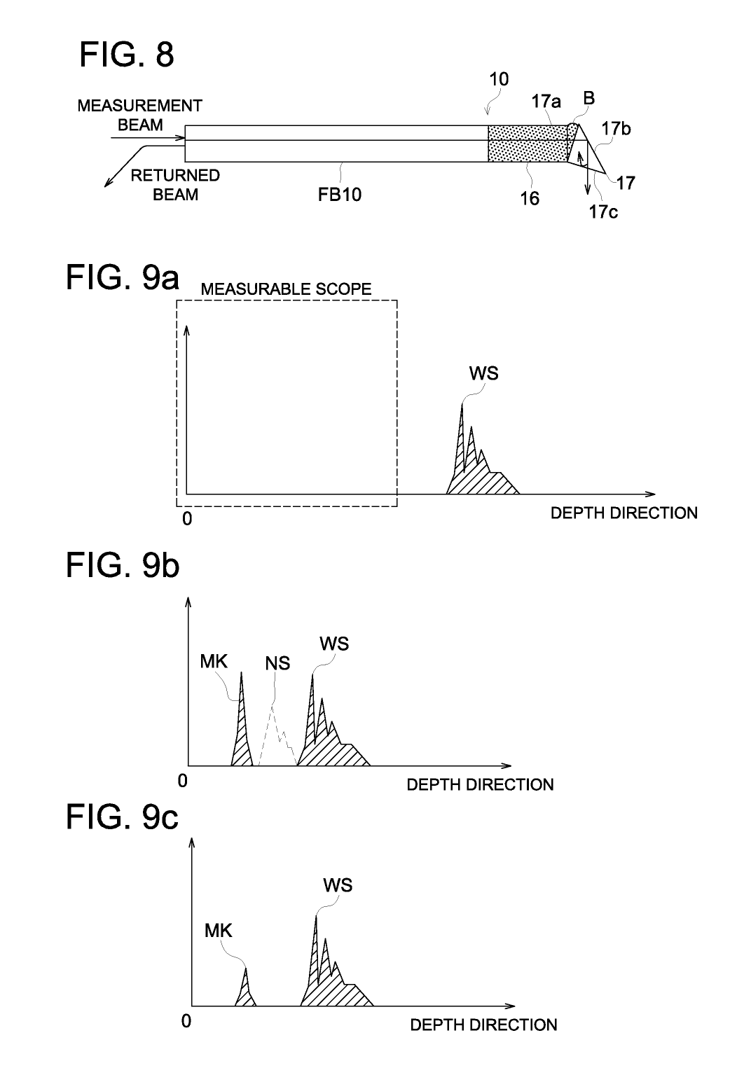

Problems during the measurement will now be detailed. FIG. 7 shows probe 10′ relating to a comparative example. FIG. 8 is a schematic cross sectional view of probe 10 relating to the present embodiment. FIG. 9 shows an example for one scanning operation of the depth tomographic signals of the measurement subject, while the signal intensity is shown on the vertical axis, and the depth length of the measurement subject is shown on the horizontal axis.

When a probe is inserted in the cavity of the living subject, a problem is that the positional relationships are not obtained between the tissues as the measurement subject and the probe. As shown in FIG. 9(a), if a measurement subject does not exist within a measurable scope, determined by the reference optical path length shown by dotted lines, no interference signal can be detected. Because if probe 10 is set on a position where the returning light beams, returning from the measurement subject, have not been generated, no signal can be obtained, even though reflection mirror MR is shifted to change the reference optical path length. Further, in case that a direct view direction is observed, when probe 10 is moved in a direction of the measurement subject, if the reference optical path length and the measurement optical path length are not equal to each other, no image signal, based on the returning light beams from the measurement subject, can be detected, so that probe 10 tends to adversely compress the measurement subject while moving. Accordingly, in the present embodiment, reflected beams, which are from partially reflecting surfaces of the prism which is near the measurement subject, are used, so that the positional relationships to the measurement subject can be detected. In this case, a problem still exists, how to use the reflected beam from the surface of the prism.

In a comparative example shown in FIG. 7, incident face 17a of isosceles triangle prism 17 is closely-attached on an end face of refractive index dispersion lens 16. Bottom face 17c of prism 17 functions to be a partially reflecting surface, so that the measurement optical path length to the partially reflecting surface can be fixed. That is, the measurement beams, coming through optical fiber FB10, enter incident face 17a of prism 17 through refractive index dispersion lens 16, and said measurement beams are reflected by inclined face 17b, subsequently, a part of said measurement beams goes downward through bottom face 17c to the measurement subject (which is not illustrated), and other measurement beams are reflected by bottom face 17c, whereby said reflected measurement beams return toward optical fiber 10 with the reflected beams, reflected by the measurement subject and coming through bottom face 17c. Reflected beams are also generated on the end face of refractive index dispersion lens 16, and on incident face 17a. However, since bottom face 17e is configured to contact to air, the refractive index of bottom face 17c is greatest, so that reflected beams from bottom face 17c are the greatest, whereby the reflected beams, reflected by other than bottom face 17c, can be neglected.

In this case, reflection mirror MR is shifted so that the reference optical path length can be adjusted to the measurement optical path length (or an optical path length further including an estimated length to the measurement subject) to bottom face 17c of fixed prism 17. Accordingly, the reflected beam reflected by bottom face 17c of prism 17 interferes to the reflected beam of the reference beam, and is shown as image signals MK in FIG. 9(b). When the tomographic images are actually obtained, since bottom face 17c of prism 17 is adjacent to the measurement subject, image signals WS appear within the measurable scope. Accordingly, it is possible that said signals are based on the reflected beams reflected by the measurement subject. However, if the amount of reflected beams coming from bottom face 17e is excessively great, a peak value of image signals MK becomes nearly equal to a peak value of image signals WK, whereby it may be impossible to determine which is image signals WS based on the reflected beam coming from the measurement beam.

Further, interfering beam detecting device 70 is configured to select the interference components of two interference signals, and to detect the difference. Accordingly, said device 70 can fundamentally cancel the reflected beam coming from bottom face 17c of prism 17, and the reflected beam coming from the measurement subject, both reflected beams exhibiting the same phase, so that no interference signals may be controlled not to appear. However, when the amount of reflected beams from bottom face 17c is excessively great, interfering beam detecting device 70 cannot effectively exhibit a canceling function. As shown by the dotted lines in FIG. 9(b), image signals NS are generated, which are noises of the interference signals between the reflected beam coming from bottom face 17c and the reflected beam coming from measurement subject S. Accordingly, image signals WS, which are based on the reflected beam from the measurement subject, cannot be distinguished from the noises. Further, since image signals WS, which is to be measured fundamentally, is overlapped on noise signals NS, precise tomographic images of the measurement subject cannot be obtained. If the difference detecting function of interfering beam detecting device 70 is improved, said problem can be solved, but an actual detecting device cannot be designed, or the production cost will excessively increase.

In the present embodiment, as shown in FIG. 8, incident face 17a of prism 17 is inclined against the end face of refractive index dispersion lens 16, having a partially reflecting surface. Subsequently, adhesive agent B is filled between them, so that prism 17 is mounted on refractive index dispersion lens 16. By this structure, an incident angle, which is incident to bottom face 17c of prism 17 exhibiting an isosceles right angle, can be changed in accordance with slanting angles of incident face 17a. Due to the change of the incident angle of bottom face 17c from the vertical incidence to the oblique incidence, the amount of reflected light beams on bottom face 17c decreases, so that the interference signals decrease, wherein said interference signals are formed of the reflected beams from bottom face 17c of prism 17 and the reflected beams of the reference beams. Accordingly, image signals MK decrease as shown in FIG. 9(c), whereby image signals MK can be easily distinguished from image signals WS, which are based on the reflected beams from the measurement subject. Further, since the reflected beams from bottom face 17c are weak, all-purpose interfering beam detecting device 70, which is obtained at a low price, can be used to cancel the reflected beams from the measurement subject, whereby the noises shown in FIG. 9(b) are effectively controlled, and image signals WS can be clearly observed. It is desirable that bottom face 17c is desired to be installed at a position where optical path length from the focal point of refractive index dispersion lens 16 is equal to or less than 10 mm.

In order to control image signals MK at a relatively low intensity from which image signals WS, based on the reflected beams from the measurement subject, can be distinguished, and in order to cancel the reflected beams from bottom face 17c and the reflected beams from the measurement subject, while all-purpose interfering beam detecting device 70, obtained at a low price, is used, it is preferable that the amount of light beams returning from bottom face 17c against the amount of measurement beams entering probe 10, (reflectance ratio) is controlled to be equal to or greater than 60 dB and equal to or less than 25 dB, wherein 1[dB]=−10 log(X[%]/100). “X” shows the ratio of the amount of beams returning from the partially reflecting surface against the amount of incident beams to the probe. In order to control the reflectance ratio to be in the predetermined scope, adjustment of probe 10 is important.

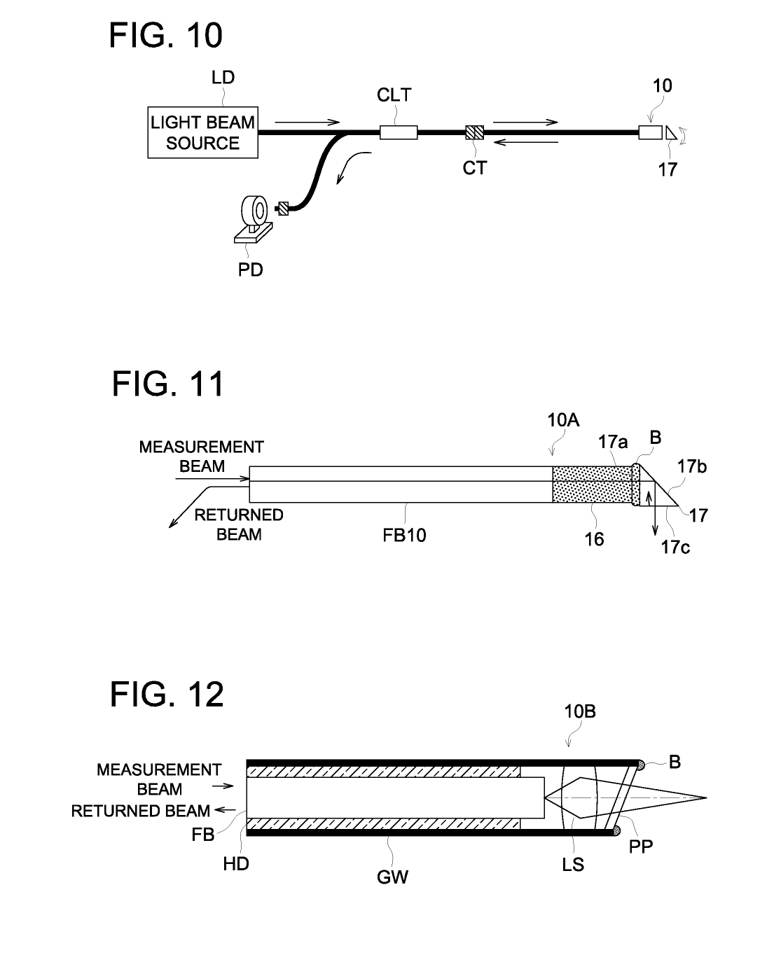

FIG. 10 is a schematic view to show the measurement device to measure the reflectance ratio. An adjusting method for the probe relating to the present embodiment will now be detailed while referring to FIG. 10. Probe 10, which is under an assembling work, is to be mounted on the measurement device through connector CT, however, it is assumed that prism 17 is not yet fixed on refractive index dispersion lens 16. Probe 10 is placed in a light absorbing space. Base light beams are emitted exhibiting a basic light amount from light beam source LD used for the measurement. Said base light beams are incident on an end of optical fiber FE, and go through probe 10, while passing through circulator CLT and connector CT.

The base light beams, having entered probe 10, pass through refractive index dispersion lens 16, and go out from its end. Then said base light beams are incident to incident face 17a of prism 17, and are reflected by inclined face 17b. Some of said beams are reflected on bottom face 17c, and remaining beams pass through bottom face 17c, and do not return. The light beams reflected by bottom face 17c are reflected by inclined face 17b, and pass through incident face 17a. Subsequently, said beams pass through refractive index dispersion lens 16, and go out from probe 10 toward the outside. Said beams are incident to circulator CLT through optical fiber FB, thereby said beams are separated to enter optical amount detecting device PD. Said optical amount detecting device PD is configured to detect the reflected beam amount, and to memorize the basic light amount of the base light beams, that is, optical amount detecting device PD is configured to calculate a reflection index, while using the basic light amount and the reflected beam amount. Accordingly, the slanting angle of incident face 17c of prism 17 against the end of refractive index dispersion lens 16 is adjusted so as to make the reflectance ratio calculated by optical amount detecting device PD to be equal to or greater than 60 dB and equal to or less than 25 dB, after that, adhering agent 13 is filled between refractive index dispersion lens 16 and prism 17, so that refractive index dispersion lens 16 and prism 17 are fixed onto each other. Further, according to the reflectance index, which is calculated by optical amount detecting device PD, the reference optical path length can be adjusted.

FIG. 11 is a schematic cross-sectional view of probe 10A relating to a variant example of the present embodiment. In the present variant example, incident face 17a of prism 17 is separated from the end of refractive index dispersion lens 16 at a predetermined distance. In accordance with said separation distance, the focal point of refractive index dispersion lens 16 changes, so that the amount of the reflected beam coming from bottom face 17c changes. For example, there are a case that the focal point exists in front of bottom face 17c, and a case that the focal point is on bottom face 17c. In the latter case, since to and from path lengths, passing through refractive index dispersion lens 16, are equal to each other, the amount of the reflected beams is greater than the former case. While the reflection ratio is measured by the measurement device shown in FIG. 10, the distance is determined, which is between the end of refractive index dispersion lens 16 and incident face 17a of prism 17. While said determined distance is kept up, adhering agent B is applied between them, whereby probe 10A is assembled.

FIG. 12 is a schematic cross-sectional view of probe 10B relating to Embodiment 2. Optical fiber FB is inserted in cylindrical guide wire GW (which is referred to as a guide barrel), and is fixed by supporting member HD (instead of this member, adhesive agent can also be used), filled between them. Further, in guide wire GW, condenser lens LS is arranged to face the inner end of optical fiber FB, and on the end of guide wire GW, transparent plane parallel plate PP (a partially reflecting surface is formed on a surface of the optical beam source side or on a surface of the measurement subject side) is arranged to be fixed, being inclined against an orthogonal direction of an axis of guide wire GW. It is desirable that plane parallel plate PP, which is a plate as an optical member having a partially reflecting surface, is installed at a position where optical path length from the focal point of condenser lens LS is equal to or less than 10 mm.

In the same way as the above-detailed embodiment, the measurement beams, entering probe 10B through optical fiber FB, are ejected from the inner end of optical fiber FB, and are focused by condenser lens LS. Subsequently, said measurement beams are ejected toward the outside of probe 10B through plane parallel plate PP, whereby said measurement beams are radiated onto the measurement subject, which is not illustrated. In accordance with the inclining angle against an orthogonal direction of the axis of guide wire GW, the reflected beam amount coming from plane parallel plate PP changes. While the reflection ratio is measured by the measurement device shown in FIG. 10, the slanting angle against plane parallel plate PP is determined. While said determined angle is kept up, plane parallel plate PP is adhered onto guide wire GW by adhering agent B, whereby probe 10B is assembled. Further, plane parallel plate PP is formed of a weak scattering substance or a rough surface, the reflected beams coming from plane parallel plate PP can easily pass through optical fiber FB, whereby probe 10B is easily assembled.

### INDUSTRIAL AVAILABLENESS

The present invention is further possible to be applied on TD (Time Domain)—OCT measurement and FD (Fourier Domain)—OCT measurement, and the structure of the optical system is not limited to the structures shown in the embodiments, as far as said structure can detect the interference signals.

### EXPLANATIONS OF THE ALPHA NUMERICAL SYMBOLS

1 optical tomographic image measurement device
1A main body
10 probe
16 refractive index dispersion lens
17 prism
70 interfering beam detecting device
B adhesive agent
BS optical dividing means
CL optical axis
CLT1 first circulator
CLT2 second circulator
CONT control device
CPL coupler
CT connector
DR1 probe driving device
DR2 reflection mirror driving device
FB optical fiber
FB10 optical fiber
FB1-FB5 optical fiber
L low coherent beam
L1 measurement beam
L2 reference beam
L3 reflected beam of measurement beam
L4 reflected beam of reference beam
LS, LS1 and LS2 lens
MR mirror
OI outlet-inlet end
CT connector
S measurement subject
SLD light beam source

1-17. (canceled)

18. A probe for an optical tomographic image measurement device, wherein the optical tomographic image measurement device includes a main body for obtaining an optical tomographic image of a measurement subject, and the probe for guiding measurement beams to the measurement subject, wherein the optical tomographic image measurement device further includes:
a light beam source for emitting low coherent beams;
a light beam dividing means for dividing the low coherent beams emitted from the light beam source into measurement beams and reference beams;
a reflection mirror for reflecting the reference beams divided by the light beam dividing means, and for giving a predetermined optical path length to the reference beams;
an optical multiplexing means for multiplexing measured reflected beams returning from the measurement subject at a time when the measurement beams from the probe are radiated onto the measurement subject, and the reference beams reflected by the reflection mirror; and
an optical interfering beam detection means for detecting optical interfering beams which are interfered with the measured reflected beams multiplexed by the optical multiplexing means and the reference beams,
wherein the probe comprises an optical member having a partially reflecting surface for reflecting some of the measurement beams at a position of a fixed measurement optical path length, and directing said some of the measurement beams to the optical multiplexing means.

19. The probe for the optical tomographic image measurement device of claim 18, wherein the optical member having the partially reflecting surface is arranged to exhibit an attitude so that a ratio of an amount of the beams returning from the partially reflecting surface against an amount of the measurement beams entering the partially reflecting surface comprises a predetermined ratio.

20. The probe for the optical tomographic image measurement device of claim 19, wherein the predetermined ratio is equal to or greater than 60 dB, and equal to or less than 25 dB.

21. The probe for the optical tomographic image measurement device of claim 18, further includes:
an optical fiber for receiving the measurement beams and outputting the measured reflected beams;
a refractive index dispersion lens for transferring the measurement beams and the measured reflected beams; and
a prism for outputting the measurement beams and receiving the measured reflected beam through the partially reflecting surface, wherein the refraction index dispersion lens and the prism are adhered onto each other, while keeping predetermined positional relationships.

22. The probe for the optical tomographic image measurement device of claim 21, wherein the refractive index dispersion lens and the prism are adhered onto each other while keeping an angle.

23. The probe for the optical tomographic image measurement device of claim 21, wherein the refractive index dispersion lens and the prism are adhered onto each other while keeping a clearance.

24. The probe for the optical tomographic image measurement device of claim 18, wherein the partially reflecting surface is placed at a position which keeps an optical path length from a focal point of the refractive index dispersion lens to be equal to or less than 10 mm.

25. The probe for the optical tomographic image measurement device of claim 18, further including:
an optical fiber for receiving the measurement beams and outputting the measured reflected beams;
a lens for transferring the measurement beams and the measured reflected beams;
a flat plate for outputting the measurement beams and receiving the measured reflected beam through the partially reflecting surface, and
a guide barrel for uniting the optical fiber, the lens and the flat plate therein, wherein the flat plate united in the lens barrel is inclined against an optical axis.

26. The probe for the optical tomographic image measurement device of claim 25, wherein the partially reflecting surface is placed at a position which keeps an optical path length from the focal point of the lens to be equal to or less than 10 mm.

27. A method for adjusting a probe for an optical tomographic image measurement device including a main body for obtaining an optical tomographic image of a measurement subject and the probe for guiding a measurement beam to the measurement subject,
wherein the optical tomographic image measurement device includes:
a light beam source for emitting low coherent beams;
a light beam dividing means for dividing the low coherent beams emitted from the beam source into measurement beams and reference beams;
a reflection mirror for reflecting the reference beams divided by the light beam dividing means and for giving a predetermined optical path length to the reference beams;
an optical multiplexing means for multiplexing measured reflected beams returning from the measurement subject at a time when the measurement beams from the probe are radiated onto the measurement subject, and the reference beams reflected by the reflection mirror; and
an optical interference detection means for detecting optical interfering beams which are interfered with the measured reflected beams multiplexed by the optical multiplexing means and the reference beams,
wherein the method for adjusting the probe includes:
a step of reflecting some of the measurement beams by a partially reflecting surface, and directing said some of the measurement beams to the optical multiplexing means,
a step of outputting the measurement beams to the partially reflecting surface,
a step of detecting returned beams returning from the partially reflecting surface, and
a step of fixing the partially reflecting surface to keep an attitude in such a manner that the amount of the returned beams returning from the partially reflecting surface exhibits a predetermined ratio against the amount of the radiated measurement beams.

28. The method for adjusting the probe of claim 27, wherein the predetermined ratio is equal to or greater than 60 dB, and equal to or less than 25 dB.

29. The method for adjusting the probe of claim 27, wherein the probe includes:
an optical fiber for receiving the measurement beams and outputting the measured reflected beams;
a refractive index dispersion lens for receiving the measurement beams and the measured reflected beam; and
a prism for outputting the measurement beams through the partially reflecting surface and receiving the measured reflected beam,
wherein the refraction index dispersion lens and the prism are adhered onto each other, while keeping a predetermined positional relationships.

30. The method for adjusting the probe of claim 29, wherein the refraction index dispersion lens and the prism are adhered onto each other while keeping an angle.

31. The method for adjusting the probe of claim 29, wherein the refractive index dispersion lens and the prism are adhered onto each other while keeping a clearance.

32. The method for adjusting the probe of claim 27, wherein the partially reflecting surface is placed at a position which keeps an optical path length from the focal point of the refractive index dispersion lens to be equal to or less than 10 mm.

33. The method for adjusting the probe of claim 27, wherein the probe includes:
an optical fiber for receiving the measurement beams and outputting the measured reflected beams;
a lens for transferring the measurement beams and the measured reflected beam;
a flat plate for outputting the measurement beam through the partially reflecting surface and receiving the measured reflected beam, and
a lens barrel for uniting the optical fiber, the lens and the flat plate, wherein the flat plate united in the lens barrel is inclined against an optical axis.

34. The method for adjusting the probe of claim 33, wherein the partially reflecting surface is placed at a position which keeps an optical path length from the focal point of the lens to be equal to or less than 10 mm.
